(19) United States
(12) Patent Application Publication
(10) Pub. No.: US 2014/0250959 A1
(43) Pub. Date: Sep. 11, 2014

(54) Magnetic lock

(71) Applicants: Linclon Tsai, El Monte, CA (US); Benn Tsai, El Monte, CA (US); Jian Hua Cai, Nanchang City (CN); Robert Ponticelli, JR., Oxnard, CA (US)

(72) Inventors: Linclon Tsai, El Monte, CA (US); Benn Tsai, El Monte, CA (US); Jian Hua Cai, Nanchang City (CN); Robert Ponticelli, JR., Oxnard, CA (US)

(21) Appl. No.: 13/815,532

(22) Filed: Mar. 9, 2013

(51) Int. Cl. E05B 27/00; E05B 15/00

(52) U.S. Cl. CPC E05B 27/0017; E05B 15/00
USPC 70/491; 70/344

(57) ABSTRACT

A lock includes a lock sleeve, a lock body is disposed in the lock sleeve in a free rotating manner, a lock assembly, an actuating member, and an actuation key. The lock body includes a lock rotor coaxially and rotatably disposed within the lock sleeve, and a lock core coaxially and rotatably disposed within the lock rotor and defined a keyway at the lock core. The lock assembly normally locks the lock core with the lock rotor in such a manner that the lock body is free to rotate within the lock sleeve. The actuation key is slidably inserted into the keyway of the lock core to unlock the key lock unit, wherein when the lock assembly is unlocked by the actuation key, the lock core is rotated within the lock rotor to drive the actuating member to rotate and to longitudinally move for actuating a latch assembly.

### BACKGROUND OF THE PRESENT INVENTION

1. Field of Invention

The present invention relates to lock and key, and more particularly to a magnetic lock, wherein a lock body is free to rotate within an unlock sleeve at a locked position and is engaged with the lock sleeve at a locked position in association with an actuation key.

2. Description of Related Arts

A conventional magnetic key lock generally comprises a sleeve coupled with a latch assembly, a lock tube disposed within the sleeve, and a magnetic arrangement for locking the lock tube with the sleeve. Accordingly, the magnetic arrangement comprises a plurality of magnetic elements radially placed at the sleeve to normally engage with the indented surfaces of the lock tube so as to lock up a rotational movement of the lock tube within the sleeve. A magnetic key is inserted into the lock tube, wherein a plurality of magnets are radially placed along the magnetic key to magnetically induct with the magnetic elements, such that the magnetic elements can be moved by the magnetic field of the magnetic key from a locked position to an unlocked position.

One disadvantage of the conventional magnetic key lock is that the lock tube is normally locked up within the sleeve. Therefore, when an object, such as an uncorrected magnetic key, is inserted into the lock tube, such magnetic key cannot be rotated in order to unlock the lock tube with the sleeve. However, when an excessive rotational force is applied to the object, the magnetic elements will be forced to damage so as to unlock the lock tube with the sleeve. Otherwise, the object may be deformed or broken by the excessive rotational force. Once the broken part of the object is left within the lock tube, the entire of the magnetic key lock cannot be actuated anymore.

Another disadvantage of the conventional magnetic key lock is that when a key with a relatively strong magnetic field, such as a universal magnetic key, is inserted into the lock tube, the strong magnetic field of such key will interfere with the magnetic elements. In other words, the lock sleeve will be unlocked by the strong magnetic field of the key from a locked position to an unlocked position.

Another disadvantage of the conventional magnetic key lock is that after the magnetic arrangement is actuated by the actuation key, the actuation key is rotate to actuate the latch assembly. However, the user must apply a relatively larger rotating force at the actuation key to drive the lock tube to rotate in order to rotate the sleeve. As a result, the latch assembly is actuated through the rotations of the sleeve and the lock tube. As it is mentioned above, when the excessive rotational force is applied at the actuation key, the stress will be created at the magnetic elements to break the locking engagement between the sleeve and the lock tube. In addition, the conventional magnetic key lock can only transmit the rotational force from the actuation key to the latch assembly through the sleeve and the lock tube, such that the latch assembly will be actuated by the rotational force only. In other words, the conventional magnetic key lock will limit the structural configuration of the latch assembly so as to limit the practical use of the latch assembly.

### SUMMARY OF THE PRESENT INVENTION

The invention is advantageous in that it provides a magnetic key lock, wherein a lock body is free to rotate within a lock sleeve at an unlocked position and is engaged with the lock sleeve at a locked position in association with an actuation key.

Another advantage of the invention is to provide a magnetic lock, wherein the lock body can be freely rotated at 360° within the lock cavity of the lock sleeve, such that when an uncorrected key or other elongated object is inserted into the keyway, the lock body will only be free-rotated to prevent any damage of the magnetic key lock by the excessive rotational force of the uncorrected key.

Another advantage of the invention is to provide a magnetic lock, wherein the latch actuator is actuated not only to rotate corresponding to the rotation of the actuation key but also to move longitudinally along the axis of the actuation key in order to actuate the latch assembly.

Another advantage of the invention is to provide a magnetic lock, which can incorporate with different types of latch assemblies, such as a fuel tank cap lock or a door latch assembly.

Another advantage of the invention is to provide a magnetic lock, which does not require to alter the original structural design of the latch assembly, so as to minimize the manufacturing cost of the latch assembly incorporating with the magnetic lock of the present invention.

Another advantage of the invention is to provide a magnetic key lock, wherein no expensive or complicated structure is required to employ in the present invention in order to achieve the above mentioned objects. Therefore, the present invention successfully provides an economic and efficient solution for providing a safe configuration for the latch assembly.

Additional advantages and features of the invention will become apparent from the description which follows, and may be realized by means of the instrumentalities and combinations particular point out in the appended claims.

According to the present invention, the foregoing and other objects and advantages are attained by a lock for a latch assembly, comprising:

a lock sleeve having a lock cavity defined therewithin;

a lock body, which is disposed in the lock cavity in a free rotating manner, comprises a lock rotor coaxially and rotatably disposed within the lock cavity, and a lock core coaxially and rotatably disposed within the lock rotor and defined a keyway at the lock core to coaxially aligned within the lock cavity;

a lock assembly which comprises a key lock unit normally locking the lock core with the lock rotor in such a manner that the lock body is free to rotate within the lock cavity for preventing the latch assembly being actuated;

a latch actuator comprising an actuating member being actuated by the lock core; and

an actuation key slidably inserted into the keyway of the lock core to unlock the key lock unit, wherein when the key lock unit is unlocked by the actuation key, the lock core is rotated by the actuation key within the lock rotor to drive the actuating member to rotate and to longitudinally move for actuating the latch assembly.

In accordance with another aspect of the invention, the present invention comprises a method of actuating a latch assembly via a lock, comprising the steps of:

(a) slidably inserting an actuation key into a keyway of a lock core of the lock body to unlock a key lock unit;

(b) when the key lock unit is unlocked by the actuation key, driving the lock core to rotate by the actuation key within the lock rotor; and

(c) during rotating the lock core, driving an actuating member to rotate and to longitudinally move for actuating the latch assembly.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a sectional view of a magnetic lock for a latch assembly according to a preferred embodiment of the present invention.

FIG. 2 is a sectional view of the magnetic lock according to the above preferred embodiment of the present invention, illustrating the actuation key inserted into the keyway to actuate the key lock unit.

FIG. 3 is a sectional view of the magnetic lock according to the above preferred embodiment of the present invention, illustrating the lock core being rotated to drive the latch actuator to rotate and the lock core being rotated to drive the latch actuator to longitudinally move for actuating the latch assembly.

FIG. 4 is a perspective view of the latch actuator of the magnetic lock according to the above preferred embodiment of the present invention.

FIGS. 5A and 5B are side views of the latch actuator of the magnetic lock according to the above preferred embodiment of the present invention.

FIGS. 6A and 6B illustrate an alternative mode of the latch actuator of the magnetic lock according to the above preferred embodiment of the present invention.

### DETAILED DESCRIPTION OF THE PREFERRED EMBODIMENT

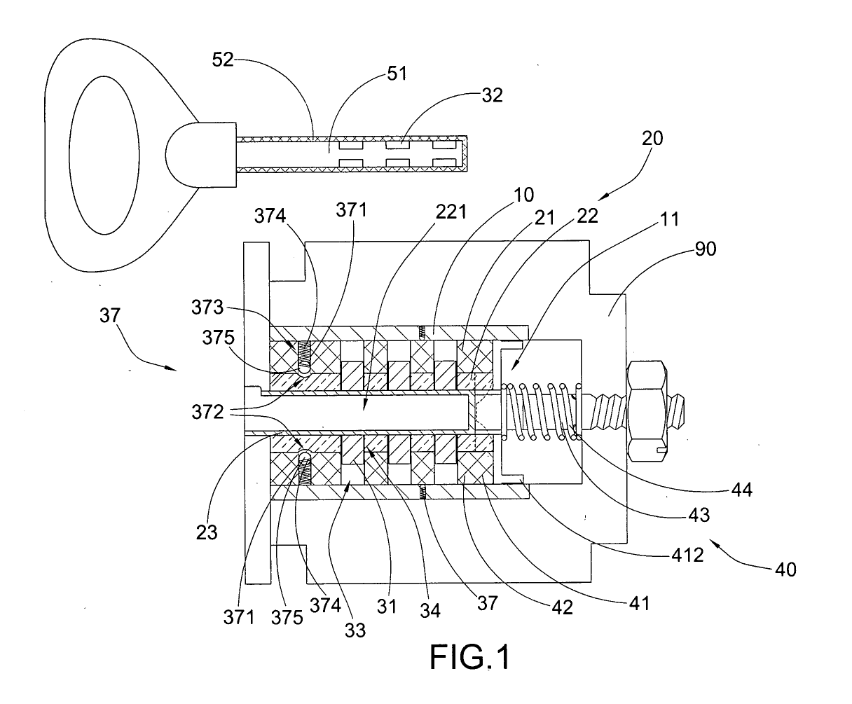

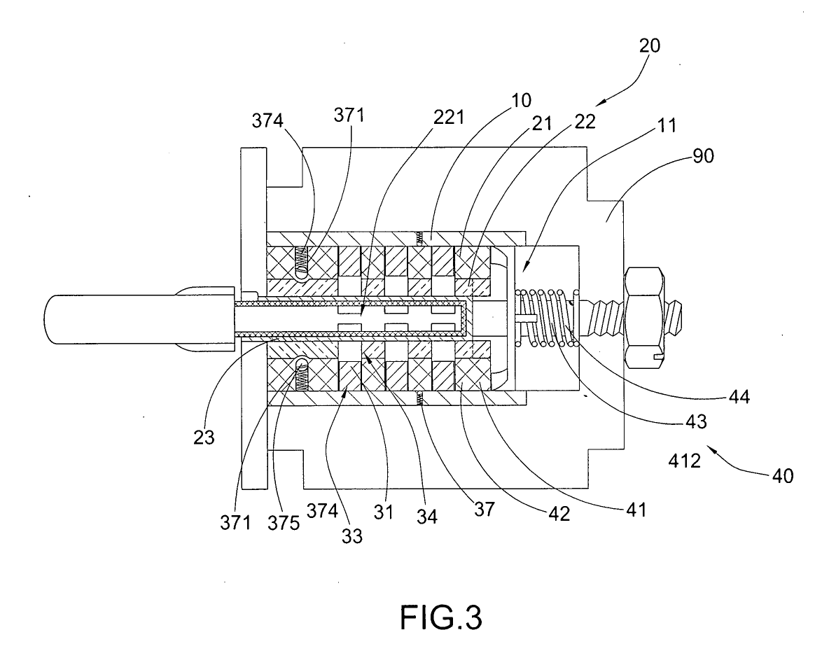

Referring to FIGS. 1 to 4 of the drawings, a magnetic lock for a latch assembly 90 according to a preferred embodiment of the present invention is illustrated, wherein the magnetic lock comprises a lock sleeve 10, a lock body 20, a lock assembly, a latch actuator 40, and an actuation key 50.

The lock sleeve 10, which is made of non-magnetic material such as brass, is arranged for coupling with the latch assembly 90, wherein the lock sleeve 10 has a lock cavity 11 defined therewithin. Accordingly, the latch assembly 90 is embodied as a fuel tank cap lock to lock at a fuel inlet of the fuel tank, wherein the latch assembly 90 has a threaded portion for rotatably coupling with threaded portion of the fuel inlet. In other words, in order to open up the fuel inlet for pumping fuel into the fuel tank, the latch assembly 90 must be actuated.

The lock body 20, which is made of non-magnetic material such as brass, is coaxially disposed in the lock cavity 11 of the lock sleeve 10 in a free rotating manner for preventing the latch assembly 90 being actuated. Accordingly, the lock body 20 can be freely rotated at 360° within the lock cavity 11 of the lock sleeve 10.

The lock body 20 comprises a lock rotor 21 coaxially and rotatably disposed within the lock cavity 11, and a lock core 22 coaxially and rotatably disposed within the lock rotor 21 and defined a keyway 221 at the lock core 22 to coaxially aligned within the lock cavity 11. The lock rotor 21 and the lock core 22 are made of non-magnetic material such as brass. Accordingly, the lock sleeve 10, the lock rotor 21, and the lock core 22 are formed in a cylindrical shape and are coaxially disposed together.

The lock assembly comprises a key lock unit 30 normally locking the lock core 22 with the lock rotor 21 in such a manner that the lock body 20 is free to rotate within the lock cavity 11 for preventing the latch assembly 90 being actuated.

According to the preferred embodiment, the key lock unit 30 is a magnetic lock unit for magnetically locking the lock core 21 within the lock rotor 21, wherein the actuation key 50 is a magnetic actuation key for actuating the magnetic lock unit by means of magnetic field.

The latch actuator 40 comprises an actuating member 41 being actuated by the lock core 22 for actuating the latch assembly 90.

The actuation key 50 is slidably inserted into the keyway 221 of the lock core 22 to unlock the key lock unit 30, wherein when the key lock unit 30 is unlocked by the actuation key 50, the lock core 22 is rotated by the actuation key 50 within the lock rotor 21 to drive the actuating member 41 to rotate and to longitudinally move for actuating the latch assembly 90.

According to the preferred embodiment, the key lock unit 30 is embodied as a magnetic key lock assembly that the key lock unit 30 can be actuated by means of magnetic field. The key lock unit 30 comprises a plurality of magnetic pins 31 and a plurality of key magnetic elements 32.

The magnetic pins 31 are radially and movably provided at the lock rotor 21 to lock up with the lock core 22, wherein each of the magnetic pins 31 has a north pole and a south pole at two ends respectively.

The key magnetic elements 32 are radially provided at the actuation key 50 corresponding to axial and radial positions of magnet pins 31, wherein when the actuation key 50 is inserted into the keyway 221, the magnetic pins 31 are repelled radially to unlock the lock core 22 with the lock rotor 21 so as to enable the lock core 22 being rotate. Preferably, the key magnetic elements 32 are embedded into the outer surface of the actuation key 50 in a hidden manner.

Preferably, each of the key magnetic elements 32 is a permanent magnet having a north pole and a south pole at two ends respectively.

Each of the magnetic pins 33 and the respective key magnetic elements 32 should be coaxially aligned in a perpendicular manner with the axis of the keyway 221 of the magnetic key lock.

Accordingly, an outer end of each of the key magnetic elements 32 has a magnetic pole same as the magnetic pole of the magnetic pins 31 so that when the actuation key 50 is inserted into the keyway 221, the magnetic pins 31 are repelled radially so as to unlock the lock core 22 within the lock rotor 21.

Furthermore, the key lock unit 30 further comprises a plurality of pin sockets 33 radially distributed on the inner circumferential surface of the lock rotor 21 and a plurality of locking seats 34 radially distrusted at the outer circumferential surface of the lock core 22, wherein the pin sockets 33 are aligned with the locking seats 34 when the lock core 22 is locked within the lock rotor 21.

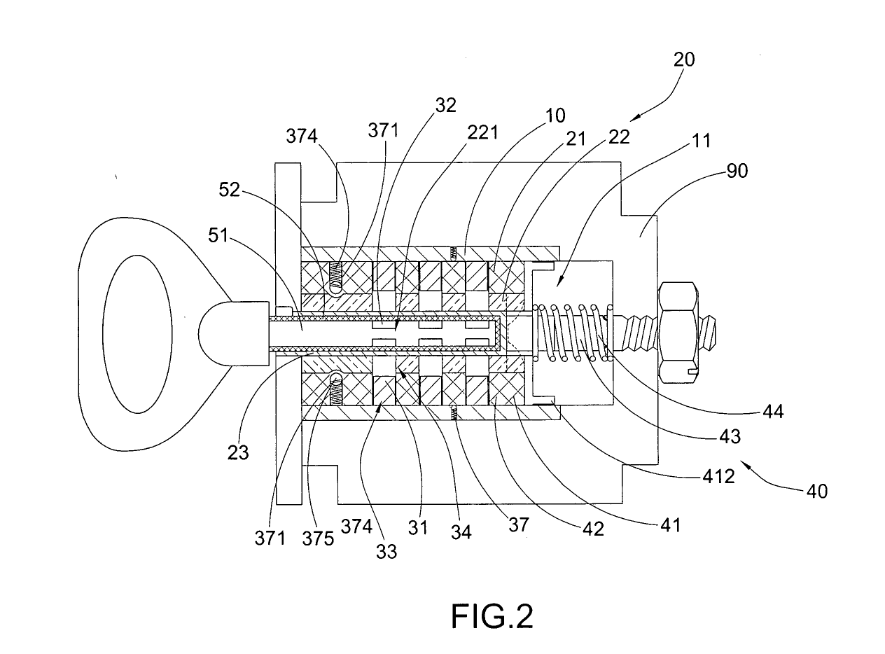

A length of each of the magnetic pins 31 must be equal or shorter than a depth of each of the pin sockets 33 such that the magnetic pins 31 can be entirely received in the pin sockets 33 respectively. A depth of each of the locking seats 34 must be smaller than the length of each of the magnetic pins 31. Therefore, at the locked position between the lock rotor 21 and the lock core 22, the outer portions of the magnetic pins 31 are received at the pin sockets 33 while the inner portions of the magnetic pins 31 are received at the locking seats 34, as shown in FIG. 1, such that the magnetic pins 31 are received at the pin sockets 33 to engage with the locking seats 34 respectively to lock up the lock core 22 within the lock rotor 21. At the unlocked position between the lock rotor 21 and the lock core 22, as shown in FIG. 2, the magnetic pins 31 are repelled radially and outwardly that the entire magnetic pins 31 are received in the pin sockets 33 to disengage with the locking seats 34 such that the lock core 22 can be rotated by the rotational movement of the actuation key 50.

As shown in FIG. 1, the lock body 20 further comprises a lock tube 23, which is made of magnetic conducting material such as iron, is fittedly disposed inside the lock core 22 to define the keyway 221 within the lock tube 23, wherein the lock tube 23 is coaxially overlapped at the inner circumferential surface of the lock core 22 to magnetically attract the magnetic pins 31. Therefore, wherein the actuation key 50 is not inserted into the keyway 221, the magnetic pins 31 are magnetically attracted by the lock tube 23 to move radially and inwardly toward the locking seats 34 until the inner portions of the magnetic pins 31 are disposed in the locking seats 34 respectively. It is worth mentioning that the outer portions of the magnetic pins 31 are disposed at the pin sockets 33 to lock up the lock core 22 within the lock rotor 21.

When the actuation key 50 is inserted into the keyway 221, the magnetic repelling force between the magnetic pins 31 and the key magnetic elements 32 is greater than the magnetic attracting force between the magnetic pins 31 and the lock tube 34. Therefore, the magnetic pins 31 will be radially and outwardly repelled by the key magnetic elements 32 that the entire magnetic pins 31 are received in the pin sockets 33 to unlock the lock core 22 within the lock rotor 21.

As shown in FIG. 1, the actuation key 50 preferably comprises a round rod shaped key body 51 for slidably inserting into the keyway 221, wherein the key magnetic elements 32 are embedded around the key body 51 corresponding to the axial and radial positions of the magnetic pins 31 respectively.

The actuation key 50 further comprises an exterior cover tube 52 to securely and entirely cover the key body 51 to hide and protect the key magnetic elements 32. Therefore, the locations of the key magnetic elements 32 along the key body 51 are hidden from outside observation for security purpose. It is worth mentioning that although each actuation key 50 can only actuate the corresponding magnetic key lock, all the actuation keys 50 may have identical appearance of a merely a round rod. The user may simply use different colors or other indications to distinguish the keys of different locks easily.

Accordingly, a locating groove is formed at the front opening of the keyway 221, wherein the actuation key 50 further has a locating latch outwardly protruded at the key body 51 and is arranged in such a manner that when the actuation key 50 is inserted to the keyway 221 at a position that the locating latch is aligned with the locating groove, the key magnetic elements 32 will be aligned with the magnetic pins 31 to unlock the lock core 22 within the lock rotor 21.

The key lock unit 30 further comprises a rotor alignment guider 37 for guiding a rotational movement of the lock rotor 21 within the lock sleeve 10.

As shown in FIG. 1, the rotor alignment guider 37 has at least a guiding slot 371 provided at the lock sleeve 10, a plurality of guiding indentions 372 radially provided at an outer surface of the lock rotor 21, and a rotor guider 373 disposed in the guiding slot 371 for applying an urging force toward the outer surface of the lock rotor 21, such that when the lock rotor 21 is rotated, the rotor guider 373 is selectively biased at one of the guiding indentions 372 to ensure the coaxially alignment between the lock rotor 21 and the lock sleeve 10.

Accordingly, the guiding slot 371 is radially formed at the lock sleeve 10. Preferably, two or more guiding slots 371 can be radially formed at the lock sleeve 10 at the opposite sides thereof.

The rotor guider 373 comprises a resilient element 374 such as a compression spring disposed at the guiding slot 371 and a biasing head 375 preferably a ball shaped element disposed at the guiding slot 371 at a position that the resilient element 374 applies the urging against the biasing head 375 toward the outer circumferential surface of the lock rotor 21. Therefore, when the lock rotor 21 is rotated, the biasing head 375 is pressed by the resilient element 374 to slide at the outer circumferential surface of the lock rotor 21 and to move from one guiding indention 372 to another guiding indention 372. In other words, when the biasing head 375 is biased at one guiding indention 372, the coaxially alignment between the lock rotor 21 and the lock sleeve 10 will be obtained. In particular, when the biasing head 375 is moved to bias from one guiding indention 372 to another guiding indention through the rotational movement of the lock rotor 21, a “Click” sound will be generated as an indicating signal to notify the user of the position of the lock rotor 21.

It is worth mentioning that when the actuation key 50 is inserted into the keyway 221, the lock core 22 is unlocked within the lock rotor 21 and is enabled to be rotated. At the same time, before the lock core 22 is rotated, the lock rotor 21 is remained at the unlocked position with respect to the lock sleeve 10. Therefore, when the lock core 22 is rotated, the lock rotor 21 may accidentally rotated as well. Accordingly, the rotor guider 373 can prevent the lock rotor 21 being rotated accidentally. Since the rotor guider 373 will apply the urging force against the lock rotor 21, the urging force functions as the holding force to hold the lock rotor 21 in position. Therefore, only the lock core 22 will be rotated until the lock rotor 21 is locked up with the lock sleeve 10.

It is worth mentioning that the rotor alignment guider 37 can be radially formed with respect to the keyway 221 that the rotor guider 373 is arranged to bias against the outer circumferential surface of the lock rotor 21 while the guiding indentions 372 are radially formed at the outer circumferential surface of the lock rotor 21. It is appreciated that the rotor alignment guider 37 can be formed at the front side of the lock sleeve 10 that the rotor guider 373 is arranged to bias against the front surface of the lock rotor 21 while the guiding indentions 372 are formed at the front surface of the lock rotor 21. In other words, the guiding slot 371 is formed at the front portion of the lock sleeve 10 and is parallel to the keyway 221.

Furthermore, the rotor alignment guider 37 can incorporate with the lock core 22 for guiding the rotational movement of the lock core 22 within the lock rotor 21. Accordingly, the guiding slot 371 can also be provided at the lock rotor 21 to receive the rotor guider 373 at the lock rotor 21, wherein the guiding indentions 372 are radially provided at the outer circumferential surface of the lock core 22, such that the rotor guider 373 is arranged for applying the urging force toward the outer circumferential surface of the lock core 22. In other words, when the lock core 22 is rotated, the rotor guider 371 is selectively biased at one of the guiding indentions 372 to ensure the key magnetic elements 32 being magnetically aligned with the magnetic pins 31 respectively, as shown in FIG. 2.

It is worth mentioning that the rotor guider 373 can prevent the lock rotor 21 being rotated accidentally. Since the rotor guider 373 will apply the urging force against the lock rotor 21, the urging force functions as the holding force to hold the lock rotor 21 in position. Therefore, when the lock core 22 is unlocked, only the lock core 22 will be rotated by the actuation key 50 while the lock rotor 21 is stationary.

As shown in FIGS. 1 to 4, the actuating member 41 is guided to move rotatably and longitudinally in order to actuate the latch assembly 90. Accordingly, during the unlocked position between the lock rotor 21 and the lock core 22, when the lock core 22 is rotated, the actuating member 41 is driven to rotate correspondingly. In addition, the lock rotor 21 is stationary. In other words, only the lock core 22 is rotated by the actuation key 50.

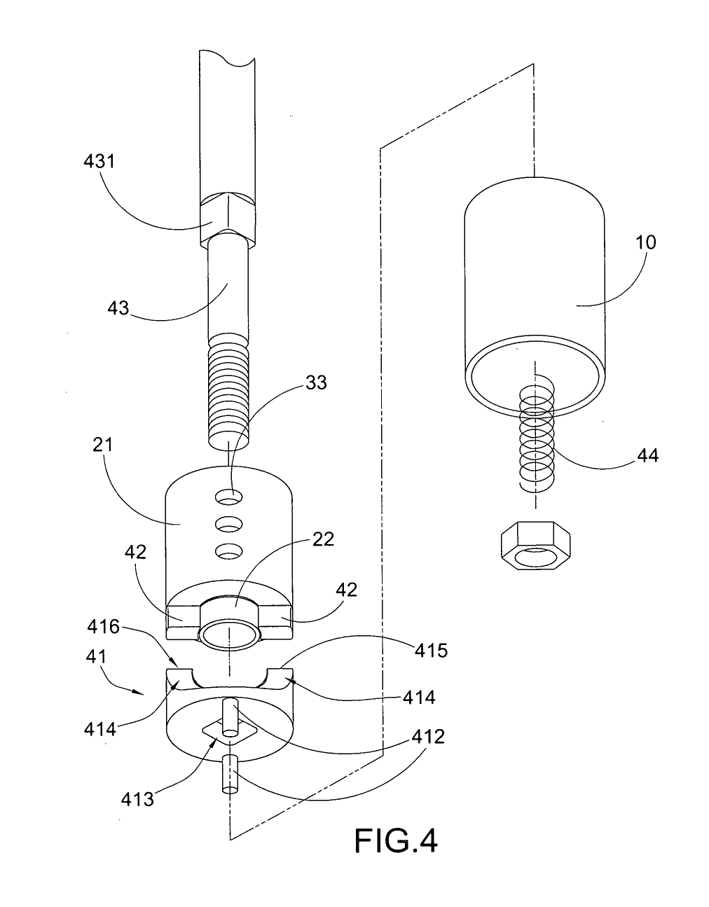

According to the preferred embodiment, the latch actuator 40 further comprises at least a guiding member 42 and longitudinally protruded from a rear end of the lock rotor 21, wherein when the actuating member 41 is driven to rotate, the actuating member 41 is also pushed by the guiding member 42 to move longitudinally for actuating the latch assembly 90. As shown in FIG. 4, two guiding members 42 are spacedly and longitudinally protruded from the rear end of the lock rotor 21.

Accordingly, the actuating member 41 comprises an actuating body 411 having a front side and a rear side, and at least a longitudinal arm 412 rearwardly extended from the rear side of the actuating body 411, wherein when the lock core 22 is rotated to drive the actuating body 411 to rotate, the front side of the actuating body 411 is pushed by the guiding member 42 to move longitudinally for actuating the latch assembly 90 by the longitudinal arm 412. Preferably, there are two longitudinal arms 412 spacedly and rearwardly extended from the rear side of the actuating body 411, such that the actuating body 411 will be pushed stably. Preferably, the actuating body 411 has a circular shape and has a diameter matching with the diameter of the lock rotor 21. In addition, the actuating member 41 is rotatably received in the lock cavity 11 of the lock sleeve 10. In other words, the length of the lock sleeve 10 is long enough to receive the lock body 20 and the actuating member 41 within the lock cavity 11. However, when the actuating

Accordingly, the actuating member 41 comprises an actuating body 411 having a front side and a rear side, and at least a longitudinal arm 412 rearwardly extended from the rear side of the actuating body 411, wherein when the lock core 22 is rotated to drive the actuating body 411 to rotate, the front side of the actuating body 411 is pushed by the guiding member 42 to move longitudinally for actuating the latch assembly 90 by the longitudinal arm 412. Preferably, there are two longitudinal arms 412 spacedly and rearwardly extended from the rear side of the actuating body 411, such that the actuating body 411 will be pushed stably. Preferably, the actuating body 411 has a circular shape and has a diameter matching with the diameter of the lock rotor 21. In addition, the actuating member 41 is rotatably received in the lock cavity 11 of the lock sleeve 10. In other words, the length of the lock sleeve 10 is long enough to receive the lock body 20 and the actuating member 41 within the lock cavity 11. However, when the actuating member 41 is pushed longitudinally, the longitudinal arm 412 will be pushed out of the lock cavity 11 of the lock sleeve 10 to actuate the lock assembly 90.

As shown in FIG. 4, the latch actuator 40 further comprises a driving shaft 43 coaxially extended from the lock core 22 to couple with the actuating member 41 in order to drive the actuating member 41 to rotate when the lock core 22 is rotated. Preferably, a coupling portion 431 of the driving shaft 43 has a non-circular cross section, such as a square cross section. The actuating member 41 has a center through slot 413 formed at center of the actuating body 411, wherein the center through slot 413 has a corresponding non-circular cross section matching with the coupling portion 431 of the driving shaft 43. Therefore, when the driving shaft 43 passes through the center through slot 413 of the actuating member 41, the coupling portion 431 of the driving shaft 43 is engaged with the center through slot 413 of the actuating member 41. As a result, when the driving shaft 43 is driven to rotate by the lock core 22, the actuating member 41 is rotated correspondingly.

The actuating member 41 further has at least a sliding surface 414 frontwardly extended at the front side thereof, wherein when the actuating body 411 is driven to rotate, the sliding surface 414 of the actuating body 41 is slid at the guiding member 42 to push the longitudinal arm 412 moving longitudinally.

In particular, the sliding surface 414 is a slanted surface extended from the front side of the actuating body 411 of the actuating member 41 at a peripheral portion thereof to align with the guiding member 42.

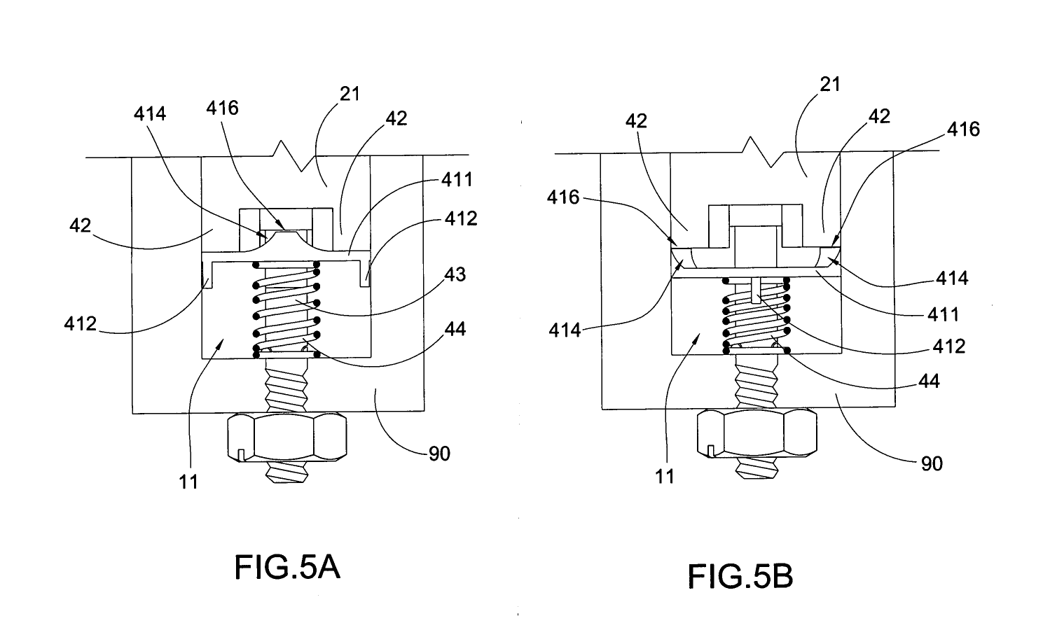

As shown in FIGS. 5A and 5B, the actuating member 41 further comprises at least a slider 415 frontwardly extended at the front side thereof, wherein the slider 415 has a trapezoid shape and defines the sliding surface 414 at each inclined surface and a flat peak surface 416 extended between the two inclined surfaces. The slider 415 is integrally extended from the front side of the actuating body 411 and has a curvature matching with the peripheral portion of the actuating body 411. The height of the slider 415, i.e. the distance between the front side of the actuating body 411 and the flat peak surface 416 of the slider 415, is large enough to push the longitudinal arm 412 out of the lock cavity 11 of the lock sleeve 10 for actuating the lock assembly 90. In other words, the height of the slider 415 is the longitudinal displacement of the actuating member 41. Therefore, at the normal position, the actuating member 41 is spaced apart from the latch assembly 90. The actuating member 41 must be moved with respect to the longitudinal displacement in order to actuate the latch assembly 90.

Furthermore, the guiding member 42 has a predetermined length that a free end of the guiding member 42 is biased against the front side of the actuating member 41 when the lock core 22 is locked within the lock rotor 21, as shown in FIG. 5A.

Once the lock core 22 is unlocked from the lock rotor 21, the lock core 22 is adapted to be rotated within the lock rotor 21. When the actuating member 41 is rotated, the free end of the guiding member 42 is slid from the front side of the actuating member 41 to the flat peak surface 416 through one of the inclined surfaces (i.e. one of the sliding surfaces 414) in order to longitudinally move the actuating member 41 toward the latch assembly 90, as shown in FIG. 5B. It is worth mentioning that when the free end of the guiding member 42 is stayed at the flat peak surface 416, the actuating member 41 is longitudinally moved to actuate the latch assembly 90.

When the actuating member 41 is kept rotating via the rotational movement of the actuation key 50, the latch assembly 90 will be actuated to rotate correspondingly. For example, the fuel tank cap lock will be unlocked.

As shown in FIGS. 1 to 4, the latch actuator further comprises a resilient element 44 coaxially coupled at the driving shaft 43 for applying an urging force against the actuating member 41 to longitudinally push the actuating member 41 away from the latch assembly 90. As shown in FIG. 4, the resilient element 44 is coaxially coupled at the driving shaft 43 at a position that an upper end of the resilient element 44 is biased against the actuating body 411 and a lower end of the resilient element 44 is blocked at a lower portion of the driving shaft 43. Therefore, the resilient element 44 will push the actuating member 41 back toward the lock rotor 21 when the free end of the guiding member 42 is slid back to the front side of the actuating member 41 from the flat peak surface 416 through the sliding surface 414. Accordingly, the resilient element 44 is a compression spring that when the actuating member 41 is moved to actuate the latch assembly 90, the compression spring will be compressed.

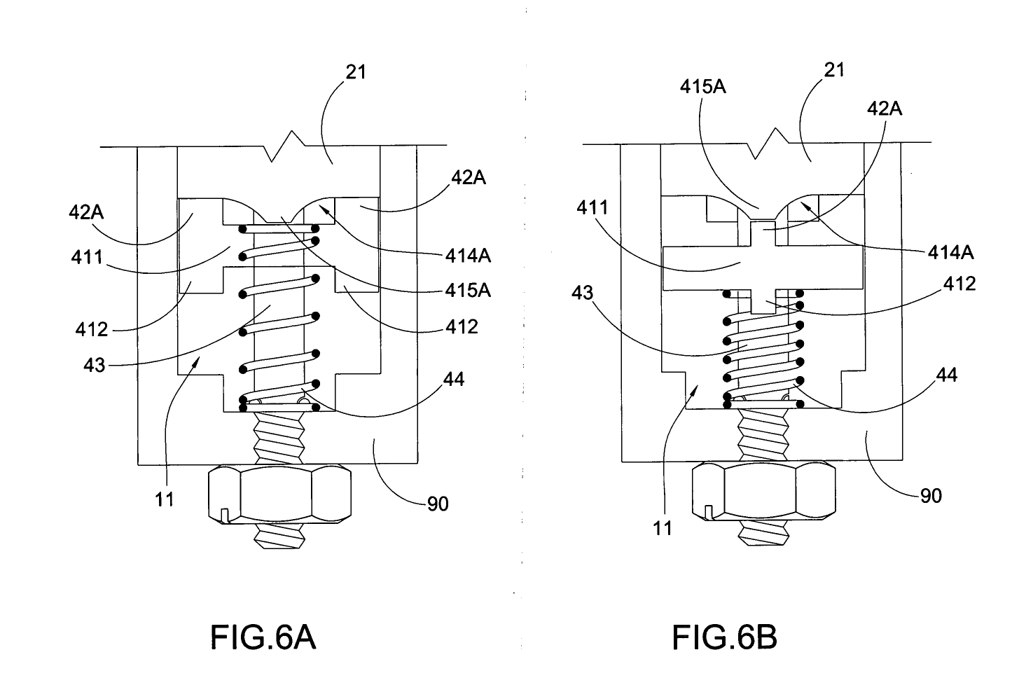

Alternatively, the sliding surface 414A can be formed at the lock rotor 21 instead of forming at the actuating member 41. As shown in FIG. 6A, the sliding surface 414A is longitudinally provided at the rear end of the lock rotor 21. In particular, the slider 415A is longitudinally protruded at the rear end of the lock rotor 21 to define the sliding surface 414A at the slider 415A. The guiding member 42A is provided at the actuating body 411 of the actuating member 41. In particular, the guiding member 42A is frontwardly extended at the front side of the actuating body 411, as shown in FIG. 6A.

Once the lock core 22 is unlocked from the lock rotor 21, the lock core 22 is adapted to be rotated within the lock rotor 21. When the actuating member 41 is rotated, the free end of the guiding member 42A is slid at the sliding surface 414A in order to longitudinally move the actuating member 41 toward the latch assembly 90, as shown in FIG. 6B. It is worth mentioning that the lock rotor 21 is stationary when the lock core 22 is unlocked from the lock rotor 21.

The present invention further provides a method of actuating a latch assembly via a lock, comprising the steps of:

(1) Slidably insert the actuation key 50 into the keyway 221 of the lock core 22 of the lock body 20 to unlock the key lock unit 30. Accordingly, the key lock unit 30 normally locks up the lock core 22 within the lock rotor 21 to prevent the rotational movement of the lock core 22 with respect to the lock rotor 21. When an uncorrected key is slidably inserted into the keyway 221 of the lock core 22, the lock body 20, i.e. the lock rotor 21 and the lock core 22, is free rotating within the lock cavity 11 of the lock sleeve 10. Therefore, when an excessive rotational force is applied by the uncorrected key, the key lock unit 30 will not be forced to damage while the lock core 22 is kept locking within the lock rotor 21.

It is worth mentioning that when the actuation key 50 is the corresponding key of the magnetic lock of the present invention, the key magnetic elements 32 at the actuation key 50 will align with the magnetic pins 31 at the lock rotor 21. Therefore, the magnetic pins 31 will be repelled outwardly to unlock the lock core 22 within the lock rotor 21. However, there the key is not the corrected key or there is not key being inserted into the keyway 221, the lock core 22 will be locked up within the lock rotor 21, such that the lock core 22 and the lock rotor 21 will free to rotate within the lock cavity 11 of the lock sleeve 10 in 360 degrees.

(2) When the key lock unit 30 is unlocked by the actuation key 50, drive the lock core 22 to rotate by the actuation key 50 within the lock rotor 21. In this state, the lock rotor 21 is stationary with respect to the lock sleeve 10. In other words, only the lock core 22 is rotated within the lock rotor 21. In other words, once the lock core 22 is unlocked, the user is able to drive the lock core 22 to rotate at a predetermined angular displacement by the actuation key 50.

(3) During rotating the lock core 22, drive the actuating member 41 to rotate and to longitudinally move for actuating the latch assembly 90.

The step (3) further comprises the following steps.

(3.1) Drive the actuating member 41 to rotate by the lock core.

(3.2) Longitudinally push the actuating member 41 by the guiding member 42 for actuating the latch assembly 90, wherein the guiding member 42 is protruded from the rear end of the lock rotor 21 to push the actuating member 41 to move longitudinally.

In the step (3.1), when the lock core 22 is rotated, the actuating member 41 is driven to rotate through the driving shaft 43. At the same time, in the step (3.2), the actuating member 41 is pushed away from the lock core 22 to actuate the latch assembly 90. It is worth mentioning that since the lock rotor 21 is stationary, the guiding member 42 will not be moved at the same time when the lock core 22 is rotated. As a result, the actuating member 41 is pushed by the guiding member 42. However, when the lock body 20 is freely rotated within the lock sleeve 10, the actuating member 41 and the guiding member 42 are rotated correspondingly. Therefore, the actuating member 41 will not be pushed by the guiding member 42.

In particular, the step (3.2) further comprises a step of guiding the guiding member 42 to slide at the sliding surface 414 in order to push the actuating member 41 longitudinally, wherein the sliding surface 414 is frontwardly extended at the front side of the actuating member 41 to align with the guiding member 42. In other words, once the lock core 22 is rotated, the guiding member 42 will slide at the sliding surface 414 such that the longitudinal displacement of the actuating member 41 will be provided via the sliding movement between the guiding member 42 and the sliding surface 414.

When the guiding member 42 is guided to slide back to its original position along the sliding surface 414 by rotating the actuation key 50 at the opposite direction, the resilient element 44 will apply the urging force against the actuating member 41 to longitudinally push the actuating member 41 away from the latch assembly 90, so as to disengage the actuating member 41 with the latch assembly 90. Once the lock core 22 is rotated back to its original position, the actuation key 50 can be slidably removed from the keyway 221 of the lock core 22 of the lock body 20. After pulling the actuation key 50 out of the keyway 221, the key lock unit 30 will lock up the lock core 22 within the lock rotor 21 again.

After fueling up the fuel, as an example, the fuel tank cap lock can be rotated back to the fuel inlet. The actuation key 50 will be rotated at the opposite direction that the lock core 22 is rotated back at a predetermined angular displacement. The actuation key 50 is rotated back to the original orientation that the magnetic pins 31 will be attracted inwardly back to their original positions so as to lock up the lock core 22 within the lock rotor 21 once the actuation key 50 is removed from the keyway 221.

It is worth mentioning that the lock sleeve 10 can be integrated with the fuel tank cap lock as a single member to minimize the manufacturing cost of the present invention. Otherwise, the lock sleeve 10 can be coaxially affixed to the fuel tank cap lock.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A lock for a latch assembly, comprising:
a lock sleeve having a lock cavity defined therewithin;
a lock body, which is disposed in said lock cavity in a free rotating manner, comprises a lock rotor coaxially and rotatably disposed within said lock cavity, and a lock core coaxially and rotatably disposed within said lock rotor and defined a keyway at said lock core to coaxially aligned within said lock cavity;
a lock assembly which comprises a key lock unit normally locking said lock core with said lock rotor in such a manner that said lock body is free to rotate within said lock cavity for preventing said latch assembly being actuated;
a latch actuator comprising an actuating member being actuated by said lock core; and
an actuation key slidably inserted into said keyway of said lock core to unlock said key lock unit, wherein when said key lock unit is unlocked by said actuation key, said lock core is rotated by said actuation key within said lock rotor to drive said actuating member to rotate and to longitudinally move for actuating said latch assembly.

2. The lock, as recited in claim 1, wherein said latch actuator further comprises at least a guiding member and longitudinally protruded from a rear end of said lock rotor, wherein when said actuating member is driven to rotate, said actuating member is also pushed by said guiding member to move longitudinally for actuating said latch assembly.

3. The lock, as recited in claim 2, wherein said actuating member comprises an actuating body having a front side and a rear side, and at least a longitudinal arm rearwardly extended from said rear side of said actuating body, wherein when said lock core is rotated to drive said actuating body to rotate, said front side of said actuating body is pushed by said guiding member to move longitudinally for actuating said latch assembly.

4. The lock, as recited in claim 3, wherein said actuating member further has at least a sliding surface frontwardly extended at said front side of said actuating body, wherein when said actuating body is driven to rotate, said sliding surface of said actuating body is slid at said guiding member to push said longitudinal arm moving longitudinally.

5. The lock, as recited in claim 4, wherein said sliding surface is a slanted surface extended from said front side of said actuating body at a peripheral portion thereof to align with said guiding member.

6. The lock, as recited in claim 5, wherein said actuating member further comprises at least a slider frontwardly extended at said front side thereof, wherein said slider has a trapezoid shape and defines said sliding surface at each inclined surface and a flat peak surface extended between said two inclined surfaces.

7. The lock, as recited in claim 6, wherein said guiding member has a predetermined length that a free end of said guiding member is biased against said front side of said actuating member when said lock core is locked within said lock rotor, wherein when said actuating member is rotated, said free end of said guiding member is slid from said front side of said actuating member to said flat peak surface through one of said inclined surfaces in order to longitudinally move said actuating member toward said latch assembly.

8. The lock, as recited in claim 5, wherein said latch actuator further comprises a driving shaft extended from said lock core to couple with said actuating member and a resilient element supported at said driving shaft for applying an urging force against said actuating member to longitudinally push said actuating member away from said latch assembly.

9. The lock, as recited in claim 8, wherein said key lock unit comprises a plurality of magnetic pins radially and movably provided at said lock rotor to lock up with said lock core and a plurality of key magnetic elements radially provided at said actuation key corresponding to axial and radial positions of magnet pins, wherein when said actuation key is inserted into said keyway, said magnetic pins are repelled radially to unlock said lock core with said lock rotor so as to enable said lock core being rotate to actuate said latch actuator.

10. The lock, as recited in claim 9, wherein said key lock unit further comprises a plurality of pin sockets radially distributed on an inner surface of said lock rotor and a plurality of locking seats radially distrusted at said lock core, wherein said magnetic pins are received at said pin sockets to engage with said locking seats respectively to lock up said lock core within said lock rotor.

11. The lock, as recited in claim 10, wherein a length of each of said magnetic pins must be equal or shorter than a depth of each of said pin sockets, such that when said magnetic pins are radially and outwardly repelled, said magnetic pins are received in said pin sockets to disengage with said locking seats respectively so as to unlock said lock core with said lock rotor.

12. The lock, as recited in claim 11, wherein said key lock unit further comprises a rotor alignment guider for guiding a rotational movement of said lock core within said lock rotor, wherein said rotor alignment guider has at least a guiding slot provided at said lock rotor, a plurality of guiding indentions radially provided at an outer surface of said lock core, and a rotor guider disposed in said guiding slot for applying an urging force toward said outer surface of said lock core, such that when said lock core is rotated, said rotor guider is selectively biased at one of said guiding indentions.

13. A method of actuating a latch assembly via a lock which comprises a lock body disposed in a lock cavity of a lock sleeve in a free rotating manner, wherein the method comprises the steps of:
(a) slidably inserting an actuation key into a keyway of a lock core of said lock body to unlock a key lock unit, wherein said key lock unit normally locks said lock core within a lock rotor of said lock body;
(b) when said key lock unit is unlocked by said actuation key, driving said lock core to rotate by said actuation key within said lock rotor; and
(c) during rotating said lock core, driving an actuating member to rotate and to longitudinally move for actuating said latch assembly.

14. The method as recited in claim 13, in the step (c), further comprising the steps of:
(c.1) driving said actuating member to rotate by said lock core; and
(c.2) longitudinally pushing said actuating member by a guiding member for actuating said latch assembly, wherein said guiding member is protruded from a rear end of said lock rotor to push said actuating member to move longitudinally.

15. The method, as recited in claim 14, wherein the step (c.2) further comprises a step of guiding said guiding member to slide at a sliding surface in order to push said actuating member longitudinally, wherein said sliding surface is frontwardly extended at a front side of said actuating member to align with said guiding member.

16. The method, as recited in claim 15, wherein said sliding surface is a slanted surface extended from said front side of said actuating member at a peripheral portion thereof to align with said guiding member.

17. The method, as recited in claim 16, further comprising a step of applying an urging force against said actuating member to longitudinally push said actuating member away from said latch assembly.

18. The method, as recited in claim 17, wherein a driving shaft is extended from said lock rotor to couple with said actuating member, wherein said resilient element is coaxially coupled at said driving shaft to bias against said actuating member.

19. The method as recited in claim 18 wherein, in the step (a), said key lock unit is a magnetic lock unit for magnetically locking said lock core within said lock rotor, wherein said actuation key is a magnetic actuation key for actuating said magnetic lock unit by means of magnetic field.

20. The method as recited in claim 19 wherein, in the step (a), said lock body is free rotating within said lock sleeve when an uncorrected key is slidably inserted into said keyway of said lock core.
